(19) United States
(12) Patent Application Publication
(10) Pub. No.: US 2024/0405903 A1
(43) Pub. Date: Dec. 5, 2024

(54) OPTIMIZING THE AMPLITUDE OF ELECTROMAGNETIC WAVES BASED ON RECEIVER FEEDBACK

(71) Applicant: Karl David Forster, Paradise Valley, AZ (US)

(72) Inventor: Karl David Forster, Paradise Valley, AZ (US)

(21) Appl. No.: 18/328,618

(22) Filed: Jun. 2, 2023

(51) Int. Cl. H04H 20/12

(52) U.S. Cl. CPC H04H 20/12

(57) ABSTRACT

The process of an electronic device changing the amplitude or power of transmitted Electromagnetic Waves (EMW), as used with wireless devices, is in response to information that the electronic device that received the EMW sends to the electronic device that transmitted the EMW. The electronic device that receives EMWs determines the quality of the EMW received and conveys this information back to the electronic device that transmitted the EMW, so that the electronic device that transmits EMWs can adjust the amplitude or power of the EMW(s) in order to optimize the wireless communication between the electronic devices.

### PRIOR ART

U.S. Pat. No. 9,838,072 B1 for Systems And Methods To Mitigate Electro-magnetic Interference In Single Twisted-pair-based Communication Systems by inventor Dai, et al., filed May 25, 2016 and issued Dec. 5, 2017, teaches how to construct a transceiver that uses an equalizer to clean up signals sent over twisted pair wires in a vehicle.

U.S. Pat. No. 2020/0057474 A1 for ELECTRONIC APPARATUS, MEASUREMENT APPARATUS, AND METHOD by inventor Pabbisetty, et al., filed Mar. 6, 2019 and issued Feb. 20, 2020, teaches how to establish a perimeter where a wireless signal cannot be detected by using sensors at various distances in order to set the power output of a transmitter so that the signal is undetectable at the sensor at a specific distance.

U.S. Pat. No. 2022/0209580 A1 for WIRELESS POWER TRANSMISSION APPARATUS FOR MINIMIZING MAGNETIC FIELD EXPOSURE BASED ON CAVITY RESONANCE by inventor Kim, et al., filed on Oct. 21, 2021 and issued on Jun. 30, 2022, teaches how to build a shielded device to transmit power wirelessly to a device in order to charge the receiving device while shielding people near the charging unit from an Electromagnetic Field (EMF).

U.S. Pat. No. 11,570,627 B1 for System, Method, And Apparatus For Providing Optimized Network Resources by inventor Montalvo, filed on Sep. 1, 2022 and issued Jan. 31, 2023, teaches how to use a list of available frequencies and how to monitor these frequencies to determine which are busy and which frequencies are available in order to determine the best fit frequency to use by wireless devices.

U. S. Pat. No. 2023/0065671 A1 for TRANSMIT POWER PRIORITIZATION IN INTER-BAND CARRIER AGGREGATION by inventor Yuan, et al., filed on Feb. 25, 2020 and issued Mar. 2, 2023, teaches how to maintain a constant maximum amount of power at the receiver of a wireless signal. It uses a predetermined list of power values per each possible carrier frequency it can use. If the carrier frequency of the wireless signal is changed, then the power is changed according to the predetermined power level for the selected frequency in order to maintain the maximum allowable power at the receiver.

### BACKGROUND OF THE INVENTION

Technical Field—The present invention generally relates to wireless communications. More specifically the invention relates to a system where a transmitter of an Electromagnetic Wave (EMW) changes the power or amplitude of the EMW in response to information provided to the transmitter by the receiver of the EMW.

### SUMMARY OF THE INVENTION

Today there are more and more electronic devices that have the ability to communicate with each other using Electromagnetic Waves (EMW). These electromagnetic waves are also known as Electromagnetic Radiation (EMR) or Electromagnetic Signals (Signals for short). The Energy contained in the electromagnetic wave is a function of the square of the Amplitude of the wave. This Energy is referred to as an Electromagnetic Field (EMF). The Power in an EMW is measured as a function of the Energy of the EMW over a period of time. Amplitude or Signal Strength is the height of an EMW. Since the Power, Energy and EMF in an EMW are all dependent on the Amplitude of the EMW, any change to the Amplitude (up or down), will cause a related change (up or down) in the Energy, Power, and EMF of a broadcast EMW. Because Amplitude and Power are interrelated, we may use the terms Amplitude and Power interchangeably.

Many protocols exist that define how electronic devices can use wireless communication methods to send and receive data. A few examples of these protocols are as follows: Wi-Fi as defined by the Institute of Electrical and Electronics Engineers, Inc. (IEEE) 802.11 standards, cellular wireless communications, and Bluetooth (registered trademark). Electronic devices use these and other protocols to communicate wirelessly by creating and receiving EMWs. Over time these protocols have been modified to focus on increasing the amount of data that is sent and received by wireless devices.

The increasing popularity of wireless devices has led to an increasing density of devices transmitting EMWs, causing problems with interference between devices. Each additional device that broadcasts EMWs into the air creates more Electrical Noise. This Electrical Noise interferes with EMWs and can cause problems for the receivers of the EMWs to properly interpret the data that is being sent to them. One common method used to overcome this Electronic Noise is to increase the amplitude or power of the broadcasted EMWs in order to make the strength of the EMW larger than the background noise. As each device keeps increasing the amplitude or power of their broadcasted EMWs, they create more Electrical Noise, adding to the problem of interference.

In addition, it has been found that EMWs at certain frequencies can cause harm to people such as cataracts, cancer, sleep disturbances, activation of genes, etc. The proliferation of wireless devices makes these health problems worse.

In addition, when an electronic device lowers the amplitude or power of its broadcast EMWs, it can use less total overall power to operate the device. This can be especially beneficial if the electronic device is battery powered. As a result, the battery life can be extended by reducing the amplitude or power of the EMWs the device broadcasts. Electronic devices that use constant power can benefit from reducing their overall power demand by reducing the amplitude or power of their broadcast EMWs.

The solution is to reduce the amplitude or power of the EMWs, which in turn, reduces the problems created by electronic wireless devices. When the amplitude or power of EMWs is reduced, there is less interference between devices, which can produce cleaner signals and in turn can improve data reliability. In addition, when there are multiple devices near each other that transmit strong EMWs, they will prevent each other from using the same frequencies. If the devices lower their EMWs amplitude or power, this would open up more options for the devices to use to communicate, which can create greater overall speeds. Additionally, reducing the amplitude or power of EMWs can also reduce the harmful health effects on people and prolong battery life.

One embodiment of the invention provides a method of dynamically modifying the amplitude or power of an Electromagnetic Wave (EMW) that is transmitted based on information provided by the receiver of the EMW. The receiver of an EMW determines the quality of the received EMW and can quantify this quality into categories such as high, sufficient, or low. The receiver can transmit information about the quality and/or category of the EMW to the transmitter of the EMW. The transmitter can use this information to adjust the amplitude or power of the EMW that it transmits to the specific receiver.

In addition, if there are multiple receivers of a transmitted EMW, each can make their own determination of the EMW quality and can send this information back to the device that transmitted the EMW. The transmitter can change the amplitude or power of EMWs that it transmits based on the intended receiver.

There are several common methods for determining the quality of a received EMW. Examples of EMW quality could be based on Signal-To-Noise ratio, Signal Strength, error rates, etc. Anything that the receiver of the EMW deems important can be used for determining the quality of the EMW.

Once the receiver has determined what it considers as a quality measurement of the EMW, it can then inform the transmitter if there is any need to make a change. For example, if the receiver determines the amplitude or power is more than sufficient, it can inform the transmitter that the transmitter does not need to use that high of amplitude or power. Conversely, if the receiver perceives the EMW as below the quality that it would prefer, then the receiver can inform the transmitter with the intent that the transmitter will increase the amplitude or power. And if the receiver determines the quality is sufficient, it can either tell the transmitter this or provide no feedback for which the transmitter will resume transmitting at its current amplitude or power levels.

In another embodiment, an electronic device can try to determine or learn the lowest amount of Power or Amplitude of an EMW to use, while still providing a signal that can be received reliably by another device. In this embodiment, the receiving electronic device communicates the quality to the transmitting electronic device. The transmitting electronic device can adjust down the amplitude or power until the receiving electronic device determines that the quality is near enough to the minimum while still providing accurate data reception. This reduction in amplitude or power can be very beneficial in reducing electronic noise and harm to people, and it can also extend battery life while still providing accurate data transmissions.

### BRIEF DESCRIPTION OF DRAWINGS

FIG. 1—illustrates an electronic device that contains a transmitter and a receiver.

FIG. 2—illustrates the basic elements of a wave.

FIG. 3—illustrates the transmitting and receiving of Electromagnetic Waves between two devices.

FIG. 4—illustrates the transmitting and receiving of Electromagnetic Waves between multiple devices.

### DETAILED DESCRIPTION OF THE INVENTION

One embodiment of the invention consists of at least two devices that can communicate with each other using Electromagnetic Waves (EMWs). Each device can act as both a transmitter of Electromagnetic Waves and also as a receiver of Electromagnetic Waves. Examples of devices that can use EMWs to communicate include portable computers, cellular phones, tablets, wireless Internet routers and access points, watches, wireless speakers, household appliances such as Internet enabled televisions, garage door openers, etc., just to name a few of the many examples of electronic devices capable of communicating with other devices.

Furthermore, the invention is not limited to the process flows described herein, as any system, process flow, or rearrangement of process steps which captures one or more of the features of the invention is within the scope of the invention. Any number of conventional techniques for communicating using a wireless protocol, such as Wi-Fi and the like, may be employed. The particular implementations and processes shown and described herein are illustrative of the invention and its best mode and are not intended to otherwise limit the scope of the invention in any way. For the sake of brevity, specific data transfer protocols and Internet standards may not be described in detail herein.

A system according to various aspects of an embodiment of the invention can be configured such that the amplitude or power of the Electromagnetic Wave can be changed based on information that the transmitter receives from the receiver of that EMW.

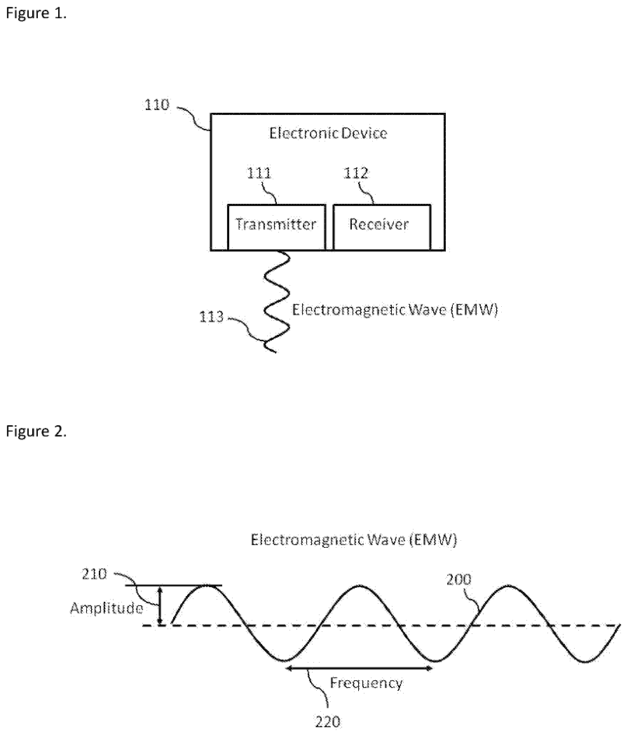

FIG. 1 shows an electronic device 110 that consists of transmitter 111 that is capable of creating Electromagnetic Waves 113 and a receiver 112 capable of receiving Electromagnetic Waves. For illustrative purposes, the transmitter 111 and the receiver 112 are presented as separate components. The transmitter 111 and the receiver 112 may be implemented as a single component that has both of these properties. For the simplicity of diagramming, the properties of transmitting (the transmitter 111) and receiving (the receiver 112) EMWs will be displayed as separate tasks.

The transmitter 111 in FIG. 1 creates an EMW that has the basic elements of FIG. 2, which shows a wave that has both amplitude 210 and a frequency 220. Both the amplitude 210 and the frequency 220 of the wave can be changed in order to broadcast data. In addition, EMWs can be combined such as to create a carrier wave with one or more additional waves added to the carrier wave. The intent of FIG. 2 is to illustrate the basic components of a wave. It is not to be inclusive of all modifications that can be made to a wave. Even when there are multiple EMWs combined together, the wave produced has amplitudes and frequencies within the wave.

The electronic device 110 in FIG. 1 has the ability to change the Amplitude of the EMW 113 transmitted by transmitter 111. The Energy in the EMW 113 is proportional to the square of the Amplitude of the EMW 113. The Power needed to transmit the EMW 113 is a function of the Energy over time. Since the Energy of the EMW 113 is proportional to the square of the Amplitude of the EMW 113, then as the Amplitude increases, the Energy and the Power also are increased. Conversely, as the Amplitude of the EMW 113 is reduced, the Energy and the Power needed to transmit the EMW 113 are also reduced. As a result, the Power, Energy, and Amplitude are all directly linked together. One could look at these items as different sides of an equation. If one looks to change the Power in an EMW they do so by changing the Amplitude. And conversely, if one changes the Amplitude, it will change the Power. For brevity in the embodiments contained herein, the term “amplitude or power” is used as interrelated terms.

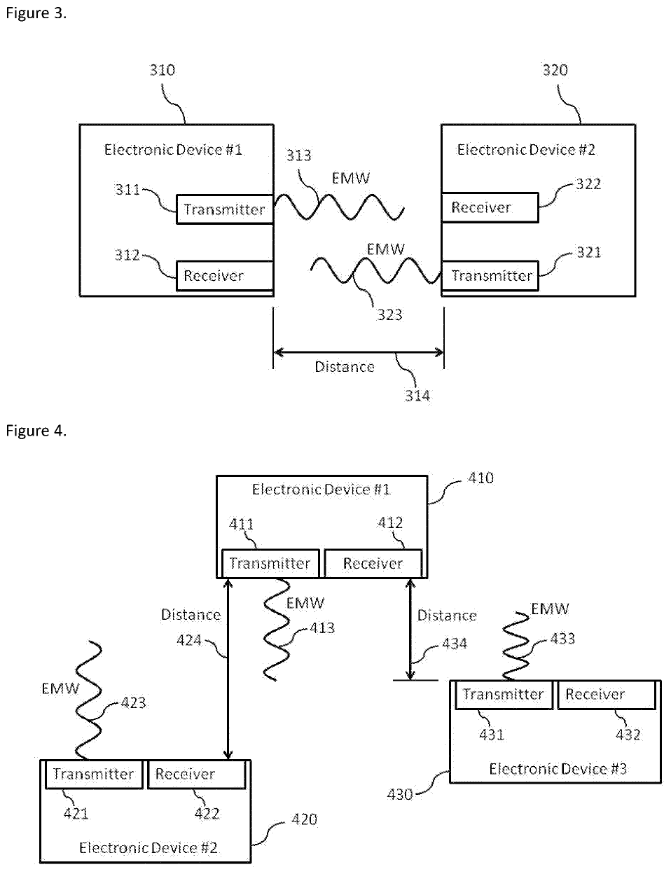

FIG. 3 illustrates the communication of two devices labeled as device 310 and device 320. Device 310 uses its transmitter 311 to transmit an EMW that is received by the receiver 322 of device 320. The transmitted EMW 313 from device 310 may contain one or more EMWs. The receiver 322 of the EMW 313 can separate the components of the EMW in order to receive data from device 310. Device 320 can also determine the quality of the EMW 313 and report this information back to device 310, by using its transmitter 321 to send EMW 323 to receiver 312 of device 310.

Device 320 determines the quality of the EMW it receives. The quality can be based on anything that is important to the receiver. Some examples may be signal-to-noise ratio, signal strength, error rates, etc. This quality measurement may be a value on a scale. Once the receiver has determined a quality measurement, it can categorize the quality of this wave into a minimum of three categories. Category one is that the quality is sufficient or good, and nothing needs to change. Category two is that the quality is high or very good such that the amplitude or power in the EMW can be reduced. Category three is that the quality of the EMW is insufficient or low, and the amplitude or power of the EMW should be increased.

Device 320 uses its transmitter 321 to communicate to device 310 information about the quality of the EMW 313 it received. This information about the quality can consist of the quality measurement value and/or the results of categorizing the quality of the received EMW 313. Device 310 can use the information about the quality of the EMW 313 it broadcast to take appropriate actions by increasing the amplitude or power, decreasing the amplitude or power, or leaving the amplitude or power as is, based on the information received from device 320.

In addition, device 310 can perform the same analysis to determine the quality of the EMW 323 received from device 320. Device 310 can communicate to device 320 information about the quality of the EMW 323 it received such as the quality measurement and/or the categorization of the quality of the received EMW 323.

In this manner, the devices 310 and 320 continue monitoring the quality of the EMWs they receive from each other in order to tell the other device to change its EMWs amplitude, power, or signal strength based on dynamic conditions. One of the conditions that can change over time could be the distance 314 between the devices. For example, if the devices are brought closer together, then the amplitude or power of their respective EMWs could be reduced. Correspondingly, if the distance between the devices is increased, the amplitudes or power of the EMWs may need to be increased. The changes to the EMWs are determined by the devices as they determine the quality of the EMWs they receive. There are other conditions that can change over time, such as changes to objects between the transmitter and the receiver, or additional devices nearby that could cause electromagnetic noise. As these events occur, the devices can determine if the quality of the EMWs they receive are affected and communicate these results to the transmitting device, requesting it to make changes to the amplitude or power of the EMWs to compensate for the changes in the environment.

FIG. 4 shows an embodiment of the invention as it is applied to multiple devices. FIG. 4 shows the interaction of three devices, and one can expand this to an unlimited number of devices. FIG. 4 shows device 410 communicating with device 420 and device 430. Each of the devices in FIG. 4 has a transmitter (411, 421, 431) and a receiver (412, 422, 432). Each of the devices 410, 420 and 430 can compute the quality of the EMWs (413, 423, 433) that they receive from another device. The devices can categorize the EMW quality and communicate information back to the device that transmitted the appropriate EMW concerning either the computed quality value and/or the categorization of the quality. The originating device can then change the amplitude or power of the EMW accordingly, per each of the devices that it communicates with. In FIG. 4, device 410 could transmit EMWs that are intended to go to device 420 at a different amplitude or power from EMWs intended for device 430 based on the information that device 410 receives from device 420 and 430. This approach would be especially useful as the distance between device 410 and the devices 420 and 430 may change over time.

As the electronic devices, such as 310 and 320 or 410, 420, and 430, adjust their amplitudes or power of their broadcast EMWs, they will also affect the Electromagnetic Field (EMF) that they produce. With this approach, one aspect of an embodiment of the invention is to reduce the EMF to the lowest possible level while simultaneously achieving reasonable data integrity. This can be accomplished by the electronic devices learning about the quality of the EMWs they broadcast as they are received by the intended receivers. By using quality measurements, the EMW broadcaster can continue to reduce the amplitude or power of its transmitted EMWs until the receiver determines it is too low. At that point the transmitter can increase the amplitude or power, so that it is generating the minimum EMF while providing sufficient quality for the two devices to communicate accurately with each other.

1. A method of changing the Amplitude or Power of a broadcasted Electromagnetic Wave (EMW) is based on information provided to the electronic device that transmitted the EMW from the electronic device that received the EMW.

2. The method of claim 1 where the electronic device that receives an EMW determines a quality value of that EMW.

3. The method of claim 1 where the quality value of an EMW is categorized into one of the following categories:
a. The quality is very good and the Amplitude or Power can be reduced;
b. The quality is sufficient and the Amplitude or Power does not need to be changed;
c. The quality is too low and the Amplitude or Power should be increased.

4. The method of claim 1 where the electronic device that receives an EMW communicates to the electronic device that transmitted the EMW information about one of the following:
a. The quality value that it determined and the category of quality of the EMW;
b. The quality value that it determined of the EMW;
c. The category of the quality of the EMW.

5. The method of claim 1 where the electronic device changes the Amplitude or Power of transmitted EMWs in response to information that it receives about the quality of its broadcast EMWs.
